(19) United States
(12) Patent Application Publication
(10) Pub. No.: US 2015/0107401 A1
(43) Pub. Date: Apr. 23, 2015

(54) PEDAL MODULE FOR A VEHICLE HAVING A CONTROL-BY-WIRE SYSTEM

(71) Applicants: The U.S.A. As Represented by the Administrator of the National Aeronautics and Space Administration, Washigton, DC (US); GM GLOBAL TECHNOLOGY OPERATIONS LLC, Detroit, MI (US)

(72) Inventors: Logan Christopher Farrell, West Lafayette, IN (US); Eduardo Herrera, Houston, TX (US); Joshua M. Figuered, Houston, TX (US); Mason M. Markee, Houston, TX (US); William J. Bluethmann, Houston, TX (US); Raymond Edward Eggleston, IV, Canton, GA (US); Justin S. Ridley, Houston, TX (US); Chunhao J. Lee, Troy, MI (US); Robert L. Vitale, Macomb Township, MI (US); Raymond Guo, Seabrook, TX (US); Steven J. Weber, Mount Clemens, MI (US); Shaun Michael Azimi, Houston, TX (US)

(73) Assignees: The U.S.A. As Represented by the Administrator of the National Aeronautics and Space Administration, Washington, DC (US); GM GLOBAL TECHNOLOGY OPERATIONS LLC, Detroit, MI (US)

(21) Appl. No.: 14/061,085

(22) Filed: Oct. 23, 2013

(51) Int. Cl. B60T 7/06

(52) U.S. Cl. CPC B60T 7/06
USPC 74/512

(57) ABSTRACT

A pedal module includes a support structure, and a lever rotatably mounted to the support structure for rotation about a rotation axis. The lever includes a lower pedal portion and an upper guide portion. A cam plate is attached to the support structure and defines a cam slot. A guide rod is coupled to the upper guide portion of the lever, and is also coupled to the cam plate to follow the cam slot. A biasing device includes a first end coupled to the support structure, and a second end coupled to the guide rod, and is operable to bias the guide rod toward the rotation axis. Resistance to movement of the lever in a first rotational direction about the rotation axis is dependent upon a spring constant of the biasing device, and a profile of the cam slot perpendicular to the rotation axis.

This invention was made with government support under NASA Space Act Agreement Number SAA-EA-10-017. The invention described herein may be manufactured and used by or for the U.S. Government for U.S. Government (i.e., non-commercial) purposes without the payment of royalties thereon or therefor.

### TECHNICAL FIELD

The invention generally relates to a pedal module for actuating a control-by-wire system of a vehicle, such as a control-by-wire propulsion system.

### BACKGROUND

Vehicles may include various systems that are electrically controlled through wires. Such systems are often referred to as a control-by-wire system. Examples of control-by-wire systems may include but are not limited to a steer-by-wire system for controlling the steering of a vehicle, a brake-by-wire system for controlling the braking of a vehicle, or a throttle-by-wire system for controlling the acceleration of the vehicle. An operator inputs a command through a control device, such as but not limited to a steering wheel, pedal, joystick, etc. The control device converts the input command into an electrical signal, which is sent to the appropriate vehicle system for execution. For example, in a brake-by-wire system, the operator may depress a brake pedal. The distance of travel of the brake pedal determines the braking force to be applied, and a vehicle controller sends an electronic signal to the braking system for execution of the requested braking force. In such a brake-by-wire system, there are no mechanical connections between the brake pedal and the brake system.

### SUMMARY

A pedal module for a vehicle having a control-by-wire vehicle system is provided. The pedal module includes a support structure, and a lever rotatably mounted to the support structure. The lever is mounted to the support structure for rotation about a rotation axis. The lever includes a lower pedal portion and an upper guide portion. A cam plate is attached to the support structure and defines a cam slot. A guide rod is coupled to the upper guide portion of the lever, and is also coupled to the cam plate to follow the cam slot. A biasing device includes a first end and a second end. The first end of the biasing device is coupled to the support structure. The second end of the biasing device is coupled to the guide rod. The biasing device is operable to bias the guide rod toward the rotation axis.

A pedal module for a vehicle having a propulsion control-by-wire system is provided. The pedal module includes a support structure. A brake lever is rotatably mounted to the support structure for rotation about a rotation axis. The brake lever includes a lower brake pedal portion and an upper brake guide portion. An acceleration lever is rotatably mounted to the support structure for rotation about the rotation axis. The acceleration lever includes a lower accelerator pedal portion and an upper accelerator guide portion. A first cam plate, a second cam plate, and a third cam plate, are each attached to the support structure, and each define a brake cam slot and an acceleration cam slot. A brake guide rod is coupled to the upper brake guide portion of the brake lever, and is coupled to the first cam plate and to the second cam plate to follow the brake cam slot. A brake biasing device includes a first end that is coupled to the support structure, and a second end that is coupled to the brake guide rod. The brake biasing device is operable to bias the brake guide rod toward the rotation axis. The brake biasing device includes a non-variable spring constant. Resistance to movement of the brake lever in a first rotational direction about the rotation axis is dependent upon the spring constant of the brake biasing device, and a profile of the brake cam slot perpendicular to the rotation axis. An acceleration guide rod is coupled to the upper accelerator guide portion of the acceleration lever, and is coupled to the second cam plate and to the third cam plate to follow the acceleration cam slot. An acceleration biasing device includes a first end that is coupled to the support structure, and a second end that is coupled to the acceleration guide rod. The acceleration biasing device is operable to bias the acceleration guide rod toward the rotation axis. The acceleration biasing device includes a non-variable spring constant. Resistance to movement of the acceleration lever in the first rotational direction about the rotation axis is dependent upon the spring constant of the acceleration biasing device, and a profile of the acceleration cam slot perpendicular to the rotation axis.

Accordingly, the spring constant of the biasing device, and the profile of the cam slot, may be selected and/or designed to achieve a desired resistance to movement of the lever, i.e., a desired force-feel profile. For example, the spring constant of the brake biasing device and the profile of the brake cam slot may be configured to mimic the feel of a mechanical brake system, which provides greater resistance to movement with a farther throw of the brake lever. Mimicking the feel of a traditional brake system, in which a brake lever is hydraulically linked to the brakes of the vehicle, makes operation of the brake-by-wire braking system more intuitive for the vehicle operator.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a vehicle

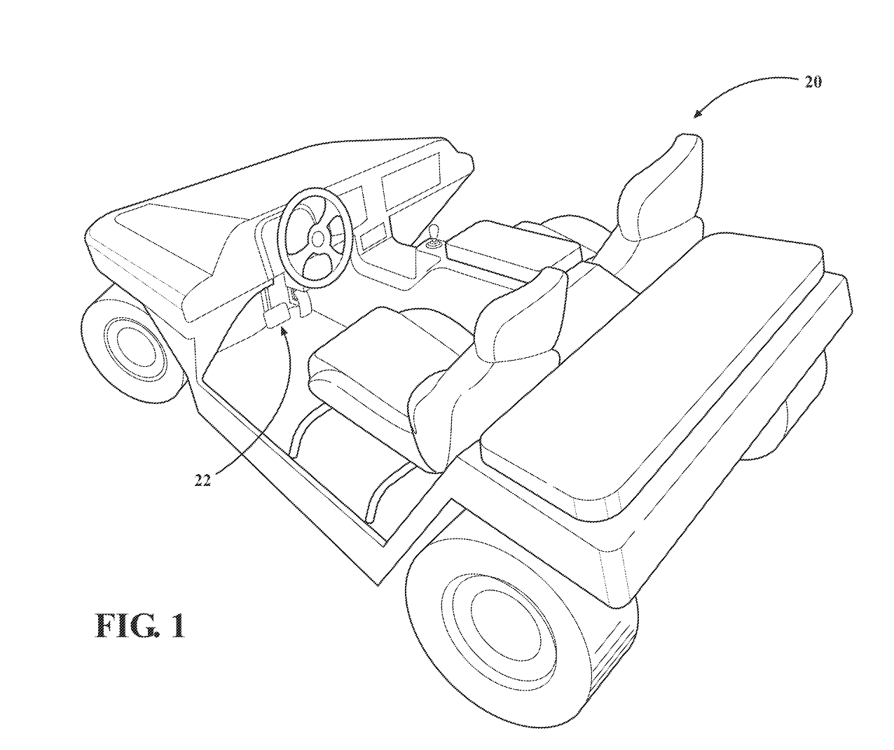

FIG. 2 is a schematic perspective view of a pedal module for the vehicle.

FIG. 3 is a schematic perspective view of the pedal module.

FIG. 4 is a schematic exploded perspective view of the pedal module.

FIG. 5 is a schematic side view of the pedal module showing a brake lever of the pedal module in an un-depressed position.

FIG. 6 is a schematic side view of the pedal module showing the brake lever in a depressed position.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a vehicle is generally shown at 20. The vehicle 20 may include any type and/or style of vehicle 20 using a control-by-wire system, such as but not limited to a drive-by-wire (acceleration) system, and/or a brake-by-wire (deceleration) system. As is known with control-by-wire systems, an operator inputs a command through a control device, such as but not limited to a pedal, joystick, etc. The control device converts the input command into an electrical signal, which is sent to a vehicle controller (not shown), which sends an electrical control signal to the appropriate vehicle system for execution. For example, the vehicle 20 may include, but is not limited to a fully electric vehicle 20 having a propulsion control-by wire system that controls both a drive-by wire acceleration system (not shown) of the vehicle 20 and a brake-by-wire brake system (not shown) of the vehicle 20.

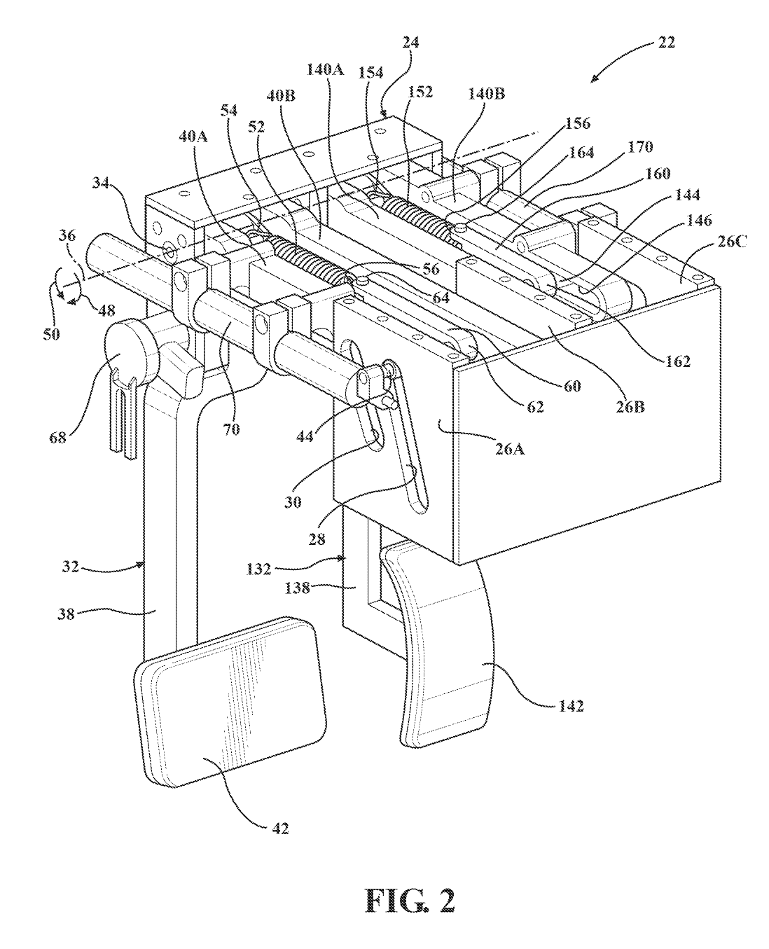

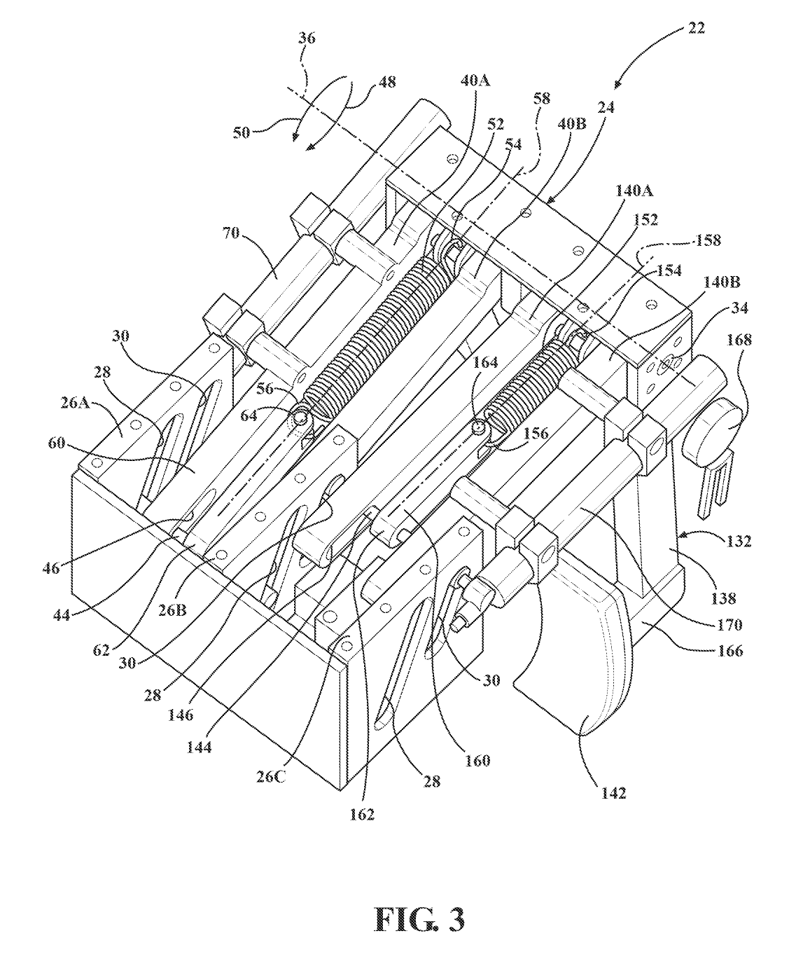

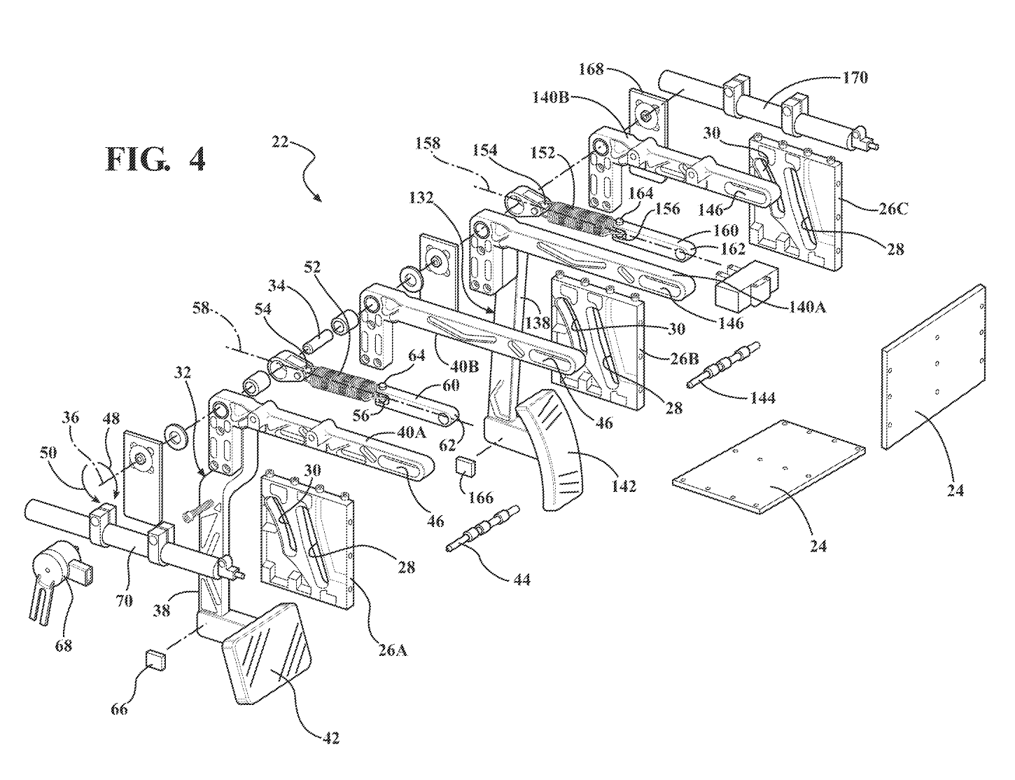

The vehicle 20 includes a pedal module 22, which is an operator input mechanism that provides an input signal for the propulsion control-by-wire system. Referring to FIGS. 2 through 4, the pedal module 22 includes a support structure 24 that is configured for attachment to a frame of the vehicle 20, and which supports the various components of the pedal module 22. The support structure 24 may be configured in any suitable manner, and may include one or more components that are attached together.

The pedal module 22 includes at least one cam plate 26. As shown, the pedal module 22 includes a first cam plate 26A, a second cam plate 26B, and a third cam plate 26C. The cam plates 26 are described generally herein with the reference numeral 26, and are described specifically and shown in the Figures by the reference numerals 26A, 26B, and 26C. The cam plates 26 are each attached to the support structure 24. The cam plates 26 may be attached to the support structure 24 in any suitable manner, such as but not limited to welding the cam plates 26 to the support structure 24, or bolting or otherwise fastening the cam plates 26 to the support structure 24 with fasteners. The first cam plate 26A, the second cam plate 26B, and the third cam plate 26C are all arranged in parallel relationship with each other, laterally spaced from each other. As shown, the second cam plate 26B is disposed between the first cam plate 26A and the third cam plate 26C. A first space is defined between the first cam plate 26A and the second cam plate 26B, and a second space is defined between the second cam plate 26B and the third cam plate 26C. Each of the cam plates 26 define a brake cam slot 28 and an acceleration cam slot 30. The brake cam slots 28 of each of the cam plates 26 are all aligned in parallel, spaced relationship with each other such that an imaginary line passing through each of the brake cam slots 28 is disposed substantially perpendicular to the cam plates 26. The acceleration cam slots 30 of each of the cam plates 26 are all aligned in parallel, spaced relationship with each other such that an imaginary line passing through each of the acceleration cam slots 30 is disposed substantially perpendicular to the cam plates 26.

A brake lever 32 is rotatably mounted to the support structure 24. The brake lever 32 may be rotatably mounted to the support structure 24 in any suitable manner. For example, the support structure 24 may include a pivot shaft 34 defining a rotation axis 36, with the brake lever 32 rotatably mounted to the pivot shaft 34 for rotation about the rotation axis 36. The brake lever 32 includes a lower brake pedal portion 38 that extends downward from the rotation axis 36 in a substantially vertical orientation, and an upper brake guide portion. The upper brake guide portion 40 is described generally herein with the reference numeral 40, and is described specifically and shown in the Figures by the reference numerals 40A, and 40B. The upper brake guide portion 40 extends outward from the rotation axis 36 in a substantially horizontal orientation. The rotation axis 36 intersects the brake lever 32 at the intersection of the lower brake pedal portion 38 and the upper brake guide portion 40. A brake pedal 42 is attached to the lower brake pedal portion 38 of the brake lever 32. As is customary in vehicles, an operator depresses the brake pedal 42 to actuate the brake system of the vehicle 20.

A brake guide rod 44 is coupled to the upper brake guide portion 40 of the brake lever 32, and is also coupled to the first cam plate 26A and the second cam plate 26B to follow the brake cam slot 28 defined by the first cam plate 26A and the second cam plate 26B. The upper brake guide portion 40 defines a brake guide slot 46 that extends along a longitudinal axis of the upper brake guide portion 40, toward the rotation axis 36. The brake guide rod 44 is disposed within the brake guide slot 46 and moveable within the brake guide slot 46 away from the rotation axis 36 and toward the rotation axis 36 in response to rotation of the brake lever 32 in a first rotational direction 48 and a second rotational direction 50 respectively. As shown, the upper brake guide portion 40 includes a first upper brake guide portion 40A and a second upper brake guide portion 40B disposed in spaced parallel relationship with each other. The first upper brake guide portion 40A and the second upper brake guide portion 40B are each disposed between the first cam plate 26A and the second cam plate 26B. The first upper brake guide portion 40A and the second upper brake guide portion 40B each define the brake guide slot 46. The brake guide rod 44 extends through the brake cam slot 28 of the first cam plate 26A and the second cam plate 26B, and also extends through the brake guide slot 46 of the first upper brake guide portion 40A and the second upper brake guide portion 40B. The brake guide rod 44 is moveable within the brake guide slot 46, and is also moveable within the brake cam slot 28.

A brake biasing device 52 interconnects the support structure 24 and the brake guide rod 44. Preferably, the brake biasing device 52 includes a single coil spring coiled about a longitudinal axis 58 that is disposed in parallel with the cam plates 26 and the upper brake guide portion 40 of the brake lever 32. However, it should be appreciated that the brake biasing device 52 may include some other type and/or style of device. For example, the brake biasing device 52 may include two or more torsion springs that interconnect the support structure 24 and the upper brake guide portion 40. The brake biasing device 52 includes a first end 54 and a second end 56. The first end 54 of the brake biasing device 52 is coupled to the support structure 24, and the second end 56 of the brake biasing device 52 is coupled to the brake guide rod 44. The brake biasing device 52 may be coupled to the support structure 24 and the brake guide rod 44 in any suitable manner. The brake biasing device 52 extends between the first end 54 and the second end 56 thereof along the longitudinal axis 58 of the brake biasing device 52. Preferably, the longitudinal axis 58 of the brake biasing device 52 intersects the rotation axis 36. A brake connecting shaft 60 includes a first shaft end 62 that is attached to the brake guide rod 44, and a second shaft end 64 that is attached to the second end 56 of the brake biasing device 52. Accordingly, the brake connecting shaft 60 interconnects the brake biasing device 52 and the brake guide rod 44. The brake biasing device 52 is operable to bias the brake guide rod 44 toward the rotation axis 36. Preferably, the brake biasing device 52 includes and/or defines a non-variable spring constant, which provides a constant return force biasing against the brake guide rod 44. However, it is contemplated that the brake biasing device 52 may include a variable spring constant to vary the resistance to movement of the brake lever 32. For example, the brake biasing device may include multiple torsion springs, with each having a different spring constant. A softer torsion spring may engage early, and a stiffer torsion spring may engage later in the pedal throw to increase the resistance to movement of the brake lever 32 during the throw of the brake lever 32.

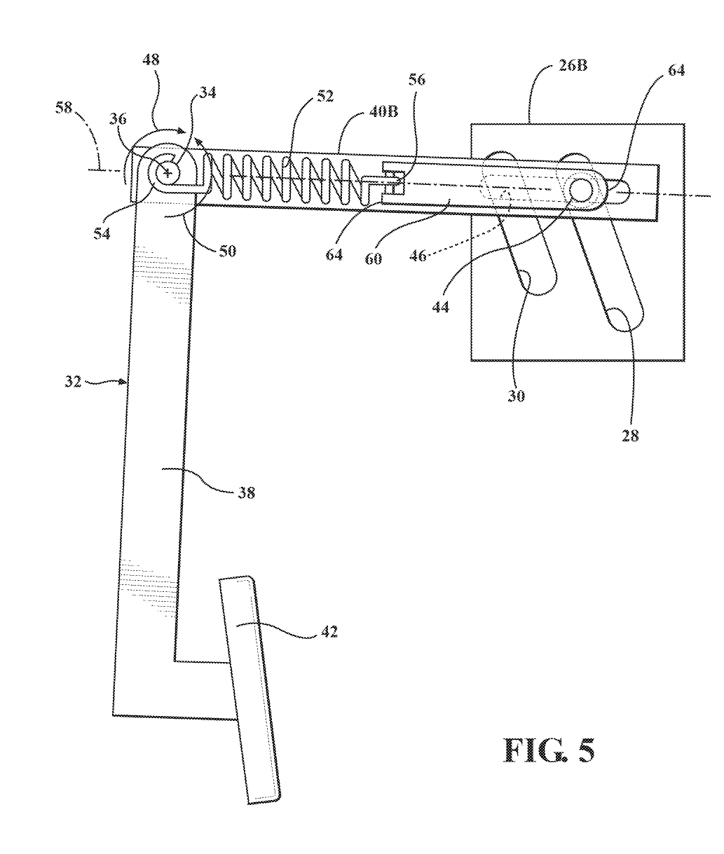

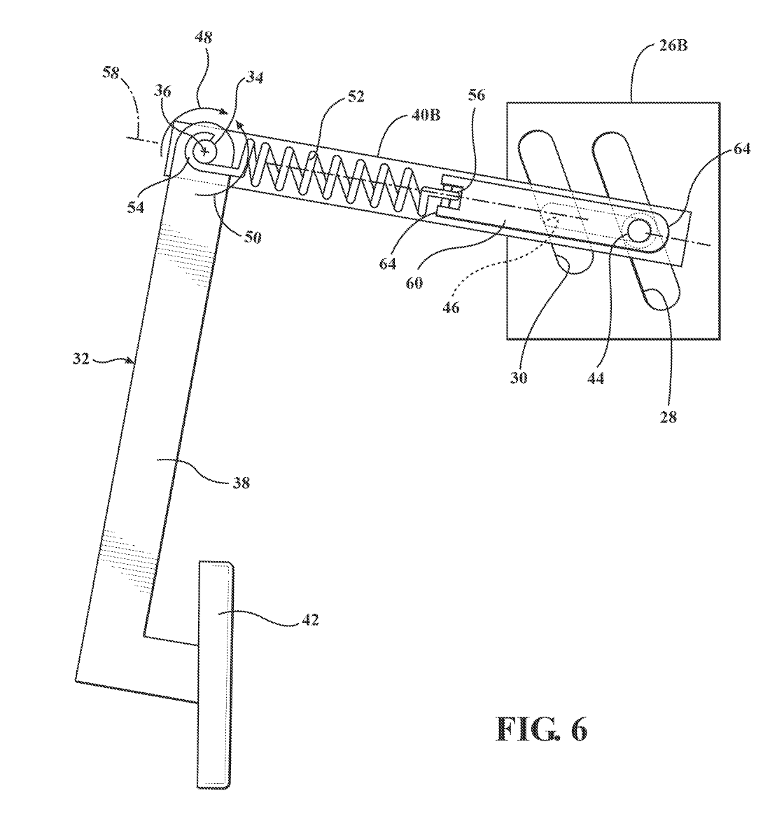

Depressing the brake pedal 42 into a depressed position, shown in FIG. 6, to actuate the brake system of the vehicle 20, rotates the brake lever 32 about the rotation axis 36 in the first rotational direction 48, which rotates the upper brake guide portion 40 in a downward vertical direction. Rotation of the upper brake guide portion 40 in the first rotational direction 48 about the rotation axis 36 moves the brake guide rod 44 in the brake cam slot 28, such that the brake guide rod 44 moves in the downward vertical direction and in a horizontal direction away from the rotation axis 36. As such, rotation of the brake lever 32 in the first rotational direction 48 elongates the brake biasing device 52. Upon the operator releasing the brake pedal 42, the return force of the brake biasing device 52 rotates the brake lever 32 in the second rotational direction 50 to return the brake lever 32 to an initial or un-depressed position, shown in FIG. 5.

The pedal module 22 includes a pre-defined brake resistance profile (operator sensed resistance to movement of the brake lever 32) resisting movement of the brake lever 32 in the first rotational direction 48. Resistance to movement of the brake lever 32 in the first rotational direction 48, about the rotation axis 36, is dependent upon the non-variable spring constant of the brake biasing device 52 and a profile of the brake cam slot 28 perpendicular to the rotation axis 36, i.e., the cross sectional shape of the brake cam slot 28 perpendicular to the rotation axis 36. By using a brake biasing device 52 with a different spring constant, or by modifying the profile of the brake cam slot 28, the pre-defined brake resistance profile may be customized to any desirable setting, such as to mimic the feel of a traditional brake pedal 42 that is mechanically or hydraulically linked to the vehicle 20 brake system. For example, a stiffer spring constant will provide a stiffer feel, or higher resistance to movement of the brake pedal 42. Furthermore, a stiffer feel, or higher resistance to movement of the brake pedal 42 may be obtained by orienting the profile of the brake cam slot 28 in a more horizontal direction, such that the profile of the brake cam slot 28 is disposed substantially horizontal relative to the rotation axis 36. Alternatively, a softer feel, or lower resistance to movement of the brake pedal 42 may be obtained by orienting the profile of the brake cam slot 28 in a more vertical direction, such that the profile of the brake cam slot 28 extends substantially vertical to the rotation axis 36. It should be appreciated that the profile of the brake cam slot 28 may be linear or constant. Alternatively, it should be appreciated that the profile of the brake cam slot 28 may be non-linear, including multiple linear segments, one or more arcuate segments, or a combination of linear and arcuate segments.

The pedal module 22 includes a brake pressure sensor 66, a brake rotation sensor 68, and a brake linear distance sensor 70. The brake pressure sensor 66 is coupled to the brake pedal 42, and is operable to sense a pressure applied to the brake pedal 42. The brake rotation sensor 68 is coupled to the brake lever 32, and is operable to sense rotation of the brake lever 32 about the rotation axis 36. The brake linear distance sensor 70 is coupled to the brake guide rod 44, and is operable to sense linear movement of the brake guide rod 44 away from and toward the rotation axis 36. The brake pressure sensor 66, the brake rotation sensor 68, and the brake linear distance sensor 70 sense the position and force applied to the brake pedal 42 and/or brake lever 32, and provide this sensed information to a vehicle controller (not shown). The vehicle controller uses the sensed information related to the position and force applied to the brake pedal 42 and/or brake lever 32 to control the actuation of the vehicle braking system.

An acceleration lever 132 is rotatably mounted to the support structure 24. The acceleration lever 132 may be rotatably mounted to the support structure 24 in any suitable manner. For example, the acceleration lever 132 may be rotatably mounted to the pivot shaft 34 for rotation about the rotation axis 36. The acceleration lever 132 includes a lower accelerator pedal portion 138 that extends downward from the rotation axis 36 in a substantially vertical orientation, and an upper accelerator guide portion 140 that extends outward from the rotation axis 36 in a substantially horizontal orientation. The upper accelerator guide portion 140 is described generally herein with the reference numeral 140, and is described specifically and shown in the Figures by the reference numerals 140A, and 140B. The rotation axis 36 intersects the acceleration lever 132 at the intersection of the lower accelerator pedal portion 138 and the upper accelerator guide portion 140. An accelerator pedal 142 is attached to the lower accelerator pedal portion 138 of the acceleration lever 132. As is customary in vehicles, an operator depresses the accelerator pedal 142 to accelerate of the vehicle 20.

An acceleration guide rod 144 is coupled to the upper accelerator guide portion 140 of the acceleration lever 132, and is also coupled to the second cam plate 26B and the third cam plate 26C to follow the acceleration cam slot 30 defined by the second cam plate 26B and the third cam plate 26C. The upper accelerator guide portion 140 defines an acceleration guide slot 146 that extends along a longitudinal axis of the upper accelerator guide portion 140, toward the rotation axis 36. The acceleration guide rod 144 is disposed within the acceleration guide slot 146 and moveable within the acceleration guide slot 146 away from the rotation axis 36 and toward the rotation axis 36 in response to rotation of the acceleration lever 132 in the first rotational direction 48 and the second rotational direction 50 respectively. As shown, the upper accelerator guide portion 140 includes a first upper accelerator guide portion 140A and a second upper accelerator guide portion 140B disposed in spaced parallel relationship with each other. The first upper accelerator guide portion 140A and the second upper accelerator guide portion 140B are each disposed between the second cam plate 26B and the third cam plate 26C. The first upper accelerator guide portion 140A and the second upper accelerator guide portion 140B each define the acceleration guide slot 146. The acceleration guide rod 144 extends through the acceleration cam slot 30 of the second cam plate 26B and the third cam plate 26C, and also extends through the acceleration guide slot 146 of the first upper accelerator guide portion 140A and the second upper accelerator guide portion 140B. The acceleration guide rod 144 is moveable within the acceleration guide slot 146, and is also moveable within the acceleration cam slot 30.

An acceleration biasing device 152 interconnects the support structure 24 and the acceleration guide rod 144. Preferably, the acceleration biasing device 152 includes a coil spring coiled about a longitudinal axis 158 that is disposed in parallel with the cam plates 26 and the upper accelerator guide portion 140 of the acceleration lever 132. However, it should be appreciated that the acceleration biasing device 152 may include some other type and/or style of device. However, it should be appreciated that the acceleration biasing device 152 may include some other type and/or style of device. For example, the acceleration biasing device 152 may include two or more torsion springs that interconnect the support structure 24 and the upper acceleration guide portion 140. The acceleration biasing device 152 includes a first end 154 and a second end 156. The first end 154 of the acceleration biasing device 152 is coupled to the support structure 24, and the second end 156 of the acceleration biasing device 152 is coupled to the acceleration guide rod 144. The acceleration biasing device 152 may be coupled to the support structure 24 and the acceleration guide rod 144 in any suitable manner. The acceleration biasing device 152 extends between the first end 154 and the second end 156 thereof along the longitudinal axis 158 of the acceleration biasing device 152. Preferably, the longitudinal axis 158 of the acceleration biasing device 152 intersects the rotation axis 36. An acceleration connecting shaft 160 includes a first shaft end 162 that is attached to the acceleration guide rod 144, and a second shaft end 164 that is attached to the second end 156 of the acceleration biasing device 152. Accordingly, the acceleration connecting shaft 160 interconnects the acceleration biasing device 152 and the acceleration guide rod 144. The acceleration biasing device 152 is operable to bias the acceleration guide rod 144 toward the rotation axis 36. Preferably, the acceleration biasing device 152 includes and/or defines a non-variable spring constant, which provides a constant return force biasing against the acceleration guide rod 144. However, it is contemplated that the acceleration biasing device 152 may include a variable spring constant to vary the resistance to movement of the acceleration lever 132. For example, the acceleration biasing device 152 may include multiple torsion springs, with each having a different spring constant. A softer torsion spring may engage early, and a stiffer torsion spring may engage later in the pedal throw to increase the resistance to movement of the acceleration lever 132 during the throw of the acceleration lever 132.

Depressing the accelerator pedal 142 into a depressed position to accelerate the vehicle 20, rotates the acceleration lever 132 about the rotation axis 36 in the first rotational direction 48, which rotates the upper accelerator guide portion 140 in a downward vertical direction. Rotation of the upper accelerator guide portion 140 in the first rotational direction 48 about the rotation axis 36 moves the acceleration guide rod 144 in the acceleration cam slot 30, such that the acceleration guide rod 144 moves in the downward vertical direction and in a horizontal direction away from the rotation axis 36. As such, rotation of the acceleration lever 132 in the first rotational direction 48 elongates the acceleration biasing device 152. Upon the operator releasing the accelerator pedal 142, the return force of the acceleration biasing device 152 rotates the acceleration lever 132 in the second rotational direction 50 to return the acceleration lever 132 to an initial or un-depressed position.

The pedal module 22 includes a pre-defined acceleration resistance profile (operator sensed resistance to movement of the acceleration lever 132) resisting movement of the acceleration lever 132 in the first rotational direction 48. Resistance to movement of the acceleration lever 132 in the first rotational direction 48, about the rotation axis 36, is dependent upon the non-variable spring constant of the acceleration biasing device 152 and a profile of the acceleration cam slot 30 perpendicular to the rotation axis 36, i.e., the cross sectional shape of the acceleration cam slot 30 perpendicular to the rotation axis 36. By using an acceleration biasing device 152 with a different spring constant, or by modifying the profile of the acceleration cam slot 30, the pre-defined acceleration resistance profile may be customized to any desirable setting, such as to mimic the feel of a traditional accelerator pedal 142 that is mechanically linked to the vehicle 20 acceleration system. For example, a stiffer spring constant will provide a stiffer feel, or higher resistance to movement of the accelerator pedal 142. Furthermore, a stiffer feel, or higher resistance to movement of the accelerator pedal 142 may be obtained by orienting the profile of the acceleration cam slot 30 in a more horizontal direction, such that the profile of the acceleration cam slot 30 extends substantially horizontal relative to the rotation axis 36. Alternatively, a softer feel, or lower resistance to movement of the accelerator pedal 142 may be obtained by orienting the profile of the acceleration cam slot 30 in a more vertical direction, such that the profile of the acceleration cam slot 30 extends substantially perpendicular to the rotation axis 36. It should be appreciated that the profile of the acceleration cam slot 30 may be linear or constant. Alternatively, it should be appreciated that the profile of the acceleration cam slot 30 may be non-linear, including multiple linear segments, one or more arcuate segments, or a combination of linear and arcuate segments.

The pedal module 22 includes an acceleration pressure sensor 166, an acceleration rotation sensor 168, and an acceleration linear distance sensor 170. The acceleration pressure sensor 166 is coupled to the accelerator pedal 142, and is operable to sense a pressure applied to the accelerator pedal 142. The acceleration rotation sensor 168 is coupled to the acceleration lever 132, and is operable to sense rotation of the acceleration lever 132 about the rotation axis 36. The acceleration linear distance sensor 170 is coupled to the acceleration guide rod 144, and is operable to sense linear movement of the acceleration guide rod 144 away from and toward the rotation axis 36. The acceleration pressure sensor 166, the acceleration rotation sensor 168, and the acceleration linear distance sensor 170 sense the position and force applied to the accelerator pedal 142 and/or acceleration lever 132, and provide this sensed information to the vehicle controller (not shown). The vehicle controller uses the sensed information related to the position and force applied to the accelerator pedal 142 and/or acceleration lever 132 to control acceleration of the vehicle 20.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A pedal module for a vehicle having a control-by-wire vehicle system, the pedal module comprising:
a support structure;
a lever rotatably mounted to the support structure for rotation about a rotation axis, and including a lower pedal portion and an upper guide portion;
a cam plate attached to the support structure and defining a cam slot;
a guide rod coupled to the upper guide portion of the lever and coupled to the cam plate to follow the cam slot; and
a biasing device having a first end coupled to the support structure and a second end coupled to the guide rod and operable to bias the guide rod toward the rotation axis.

2. The pedal module as set forth in claim 1 wherein the upper guide portion defines a guide slot extending along a longitudinal axis of the upper guide portion toward the rotation axis, with the guide rod disposed within the guide slot and moveable within the guide slot away from the rotation axis and toward the rotation axis in response to rotation of the lever in a first rotational direction and a second rotational direction respectively.

3. The pedal module as set forth in claim 2 wherein rotation of the brake lever about the rotation axis in the first rotational direction rotates the upper guide portion in a downward vertical direction, thereby moving the guide rod in the cam slot such that the guide rod moves in the downward vertical direction and a horizontal direction away from the rotation axis, thereby elongating the biasing device and providing a pre-defined resistance profile resisting movement of the brake lever in the first rotational direction.

4. The pedal module as set forth in claim 1 wherein the cam plate includes a first cam plate and a second cam plate disposed in spaced parallel relationship with each other, with the first cam plate and the second cam plate each defining the cam slot, wherein the guide rod is coupled to the cam slot in the first cam plate and the cam slot in the second cam plate to follow the profile of the cam slot.

5. The pedal module as set forth in claim 4 wherein the upper guide portion includes a first upper guide portion and a second upper guide portion disposed in spaced parallel relationship with each other, with the first upper guide portion and the second upper guide portion defining the guide slot, and with the first upper guide portion and the second upper guide portion each disposed between the first cam plate and the second cam plate.

6. The pedal module as set forth in claim 1 further comprising a connecting shaft having a first shaft end attached to the guide rod and a second shaft end attached to the second end of the biasing device.

7. The pedal module as set forth in claim 1 wherein the biasing device includes a single coil spring.

8. The pedal module as set forth in claim 1 wherein the biasing device includes a non-variable spring constant.

9. The pedal module as set forth in claim 8 wherein a force-feel resistance profile resisting movement of the lever in a first rotational direction about the rotation axis is dependent upon the spring constant of the biasing device and a profile of the cam slot perpendicular to the rotation axis.

10. The pedal module as set forth in claim 1 further comprising a pedal attached to the lower pedal portion of the brake lever.

11. The pedal module as set forth in claim 10 further comprising a pressure sensor coupled to the pedal and operable to sense a pressure applied to the pedal.

12. The pedal module as set forth in claim 1 further comprising a rotation sensor coupled to the lever and operable to sense rotation of the lever about the rotation axis.

13. The pedal module as set forth in claim 1 further comprising a linear distance sensor coupled to the guide rod and operable to sense linear movement of the guide rod away from and toward the rotation axis.

14. The pedal module as set forth in claim 1 wherein the biasing device extends between the first end and the second end thereof along a longitudinal axis of the biasing device, and wherein the longitudinal axis of the biasing device intersects the rotation axis.

15. A pedal module for a vehicle having a propulsion control-by-wire system, the pedal module comprising:
a support structure;
a brake lever rotatably mounted to the support structure for rotation about a rotation axis, and including a lower brake pedal portion and an upper brake guide portion;
an acceleration lever rotatably mounted to the support structure for rotation about the rotation axis, and including a lower accelerator pedal portion and an upper accelerator guide portion;
a first cam plate, a second cam plate, and a third cam plate, each attached to the support structure and defining a brake cam slot and an acceleration cam slot;
a brake guide rod coupled to the upper brake guide portion of the brake lever and coupled to the first cam plate and to the second cam plate to follow the brake cam slot;
a brake biasing device having a first end coupled to the support structure and a second end coupled to the brake guide rod and operable to bias the brake guide rod toward the rotation axis, wherein the brake biasing device defines a non-variable spring constant;
an acceleration guide rod coupled to the upper accelerator guide portion of the acceleration lever and coupled to the second cam plate and to the third cam plate to follow the acceleration cam slot; and
an acceleration biasing device having a first end coupled to the support structure and a second end coupled to the acceleration guide rod and operable to bias the acceleration guide rod toward the rotation axis, wherein the acceleration biasing device defines a non-variable spring constant;
wherein resistance to movement of the brake lever in a first rotational direction about the rotation axis is dependent upon the spring constant of the brake biasing device and a profile of the brake cam slot perpendicular to the rotation axis; and
wherein resistance to movement of the acceleration lever in the first rotational direction about the rotation axis is dependent upon the spring constant of the acceleration biasing device and a profile of the acceleration cam slot perpendicular to the rotation axis.

16. The pedal module as set forth in claim 15 wherein the upper brake guide portion defines a brake guide slot extending along a longitudinal axis of the upper brake guide portion toward the rotation axis, with the brake guide rod disposed within the brake guide slot and moveable within the brake guide slot away from the rotation axis and toward the rotation axis in response to rotation of the brake lever in the first rotational direction and a second rotational direction respectively, and wherein the upper accelerator guide portion defines a acceleration guide slot extending along a longitudinal axis of the upper accelerator guide portion toward the rotation axis, with the acceleration guide rod disposed within the acceleration guide slot and moveable within the acceleration guide slot away from the rotation axis and toward the rotation axis in response to rotation of the acceleration lever in the first rotational direction and the second rotational direction respectively.

17. The pedal module as set forth in claim 16 further comprising a brake connecting shaft having a first shaft end attached to the brake guide rod and a second shaft end attached to the second end of the brake biasing device, and a acceleration connecting shaft having a first shaft end attached to the acceleration guide rod and a second shaft end attached to the second end of the acceleration biasing device.

18. The pedal module as set forth in claim 16 further comprising a brake pedal attached to the lower brake pedal portion of the brake lever, and an accelerator pedal attached to the lower accelerator pedal portion of the acceleration lever.

19. The pedal module as set forth in claim 18 further comprising:
a brake pressure sensor coupled to the brake pedal and operable to sense a pressure applied to the brake pedal;
an acceleration pressure sensor coupled to the accelerator pedal and operable to sense a pressure applied to the accelerator pedal,
a brake rotation sensor coupled to the brake lever and operable to sense rotation of the brake lever about the rotation axis;
an acceleration rotation sensor coupled to the acceleration lever and operable to sense rotation of the acceleration lever about the rotation axis;
a brake linear distance sensor coupled to the brake guide rod and operable to sense linear movement of the brake guide rod away from and toward the rotation axis; and
an acceleration linear distance sensor coupled to the acceleration guide rod and operable to sense linear movement of the acceleration guide rod away from and toward the rotation axis.

20. The pedal module as set forth in claim 15 wherein the brake biasing device extends between the first end and the second end thereof along a longitudinal axis of the brake biasing device, and wherein the longitudinal axis of the brake biasing device intersects the rotation axis, and wherein the acceleration biasing device extends between the first end and the second end thereof along a longitudinal axis of the acceleration biasing device, and wherein the longitudinal axis of the acceleration biasing device intersects the rotation axis.
